(19) United States
(12) Patent Application Publication
(10) Pub. No.: US 2026/0001984 A1
(43) Pub. Date: Jan. 1, 2026

(54) HIGH STRAIN HARDENING POLYETHER-ESTER MATERIAL APPLICABLE TO ELASTIC FIBER

(71) Applicant: SHINKONG SYNTHETIC FIBERS CORPORATION, TAIPEI CITY (TW)

(72) Inventors: CHING-YI LI, TAIPEI CITY (TW); CHENG-TIEN HSIEH, TAIPEI CITY (TW)

(21) Appl. No.: 19/253,264

(22) Filed: Jun. 27, 2025

(30) Foreign Application Priority Data
Jun. 28, 2024 (TW) 113124250

(51) Int. Cl. C08G 63/672; C08K 3/22; C08K 3/36; D01F 1/10; D01F 6/84

(52) U.S. Cl. CPC C08G 63/672; C08K 3/22; C08K 3/36; D01F 1/10; D01F 6/84; C08K 2003/2241; C08K 2201/005; D10B 2401/061; D10B 2401/062; D10B 2401/063

(57) ABSTRACT

This disclosure provides a polyether-ester elastomer with a high stain hardening ability, wherein the thermoplastic polyether-ester elastomer contains polyester hard segment, polyether soft segment and at least one inorganic compound. The inorganic compound is selected from the group consisting of silicon dioxide, titanium dioxide, zinc oxide, aluminum oxide, aluminum silicate, zirconium oxide, potassium titanate and derivatives thereof. This disclosure also provides a polyether-ester elastic fiber which is characterized by a stress-strain curve with a specific profile. This disclosure also provides a process for preparing the polyether-ester elastomer, a process for preparing the polyether-ester elastomer fiber, use of the polyether-ester elastomer or polyether-ester elastomer fiber, and a polyether-ester elastic material comprising the polyether-ester elastomer.

### CROSS-REFERENCE TO RELATED APPLICATIONS

This application claims the benefit of priority of Taiwan Patent Application No. 113124250, filed on Jun. 28, 2024, and the disclosure of which is herein incorporated by reference in its entirety.

### FIELD OF THE INVENTION

The present invention relates to a polyether-ester elastomer, in particular to a thermoplastic polyether-ester elastomer (TPEE).

### BACKGROUND OF THE INVENTION

Polyurethane fiber is also known as spandex fiber, Spandex or OP fiber. Because of its high elasticity, high recovery rate (i.e., resilience), and its light weight, softness and smoothness, it can be used as an elastic fibrous material, and it can be spun with other materials and can maintain the characteristics of the two fibers. Polyurethane fibers are often combined with polyester fibers to make synthetic yarns or composite yarns that are commonly seen on the market. Although they perform well in apparel applications, such composites make it more difficult to recycle or separate the materials afterwards, thus reducing the advantage of polyester as a recycling material.

More than 90% of polyurethane elastic fibers are produced by the Dry Spinning method around the world. In this method, oligo diols and diisocyanate monomers are first mixed in a reaction vessel to react and prepare a prepolymer (usually at a ratio of 1:2 oligo diols to diisocyanate monomers). Then, the prepolymer and an equal amount of diamine are subjected to a chain-growth polymerization reaction to form a polymer. During the spinning process, a solvent with good solubility such as dimethylacetamide is first used to prepare a spinning solution, and then the spinning solution is drawn into filaments. After the solvent in the spinning solution evaporates, the polymer filaments gradually solidify. After stretching, shaping, washing, drying and other post-processing processes, polyurethane elastic fibers can be obtained. (See Jinlian Hu, Jing Lu & Yong Zhu (2008), New Developments in Elastic Fibers, Polymer Reviews, 48:2, 275-301.) Due to the volatilization of solvents in the production process, it is environmentally unfriendly.

Polyurethane elastic fiber is composed of long amorphous segments and short hard segments. Since the glass transition temperatures (Tg) of the two segments are lower than the room temperature and higher than the room temperature respectively, the two segments are thermodynamically incompatible. Hence, the polyurethane has the characteristic of microphase separation. During the phase separation, the rigid structure of the hard segments and the intermolecular hydrogen bonds formed improve the mechanical strength and thermal stability, while the soft segments form irregular curls, resulting in high deformation properties. In addition, a cross-linking agent will be added during dry spinning of polyurethane elastic fibers, which enhances the physical properties of polyurethane elastic fibers through chemical crosslinking, resulting in the special high resilience and mechanical properties (See Jinlian Hu, Jing Lu & Yong Zhu (2008) New Developments in Elastic Fibers, Polymer Reviews, 48:2, 275-301). The tensile stress-strain diagram of the polyurethane elastic fiber shows that the stress is very low in the low deformation area and the variation of stress is very high in the high deformation area. The overall curve resembles an exponential curve. This phenomenon of exponential bending deformation, in which the stress required for stretching increases significantly, is due to the high deformation resistance of the polyurethane elastic fiber structure, known as a high strain hardening.

The structure of thermoplastic polyether-ester elastomer is a block copolymer composed of short hard segments and long soft segments. This special structure forms a physical crosslinking similar to the phase separation of polyurethane, which makes thermoplastic polyether-ester elastic fibers have good elasticity and light weight, and they are recyclable polyester series materials, and are environmentally friendly recycled materials with high potential and high functionality. Furthermore, compared to the spinning process of polyurethane elastic fibers, the spinning process of thermoplastic polyether-ester elastic fibers is to melt the polymer by heating, extrude it through the spinning nozzles, and then cool it to form fibers. This process does not require solvents and is therefore more environmentally friendly. If thermoplastic polyether-ester elastic material can be used to replace traditional polyurethane elastic fibers, a single polyester material can be used for a whole garment, thereby reducing the difficulty of subsequent recycling and separation.

Nowadays, scholars and people in related fields are trying to replace the current application of polyurethane elastic fibers with thermoplastic polyether-ester elastic fibers. However, there have been technical difficulties, and no breakthrough has been achieved so far. Hence, there has not yet been a commercially available thermoplastic polyether-ester clastic material that can completely replace the polyurethane elastic fiber. The reasons are as follows.

First, the thermoplastic polyether-ester elastomer is copolymerized from hard segments and soft segments, which is an elastic material produced by physical crosslinking of the two segments with different characteristics. When the thermoplastic polyether-ester elastomer is stretched, and if the average degree of polymerization of the hard segments is small (i.e., the proportion of hard segments in the whole material is low), the crystallization is not perfect enough to cause lattice rupture, and permanent deformation will occur. While the soft segments are not crystallized in static state, the stress-induced crystallization also occurs in the stretching process. Hence, the deformation cannot be completely restored after the applied external force is withdrawn, which will also result in permanent deformation. However, when the proportion of hard segments of thermoplastic polyether-ester elastomer is higher (i.e., >50 wt %), the crystallization is more complete and the thermoplastic polyether-ester elastomer has the ability to resist deformation, but it is still difficult to apply the material to clothing products due to the overall poor fiber properties. In contrast, when the proportion of thermoplastic polyether-ester elastomer in the hard segment is low (<50 wt %), although the hardness is low and the resulted clothing products are softer and have a better touch and feel, it is more prone to lattice rupture and permanent deformation due to the imperfection of the crystallization, resulting in poor fiber resilience. The aforementioned structural properties make it difficult to replace polyurethane elastic fibers with thermoplastic polyether-ester elastomers in fiber applications (see patent CN1480570A). Therefore, some scholars believe that mixing different types of soft segments can make thermoplastic polyether-ester elastomers with low hardness less prone to induce crystals during stretching, thereby avoiding permanent deformation and thus increasing the resilience (see patent CN1480570A). However, this method has a limited effect in increasing the resilience, which is less than 90%.

Second, to obtain better fiber properties so that thermoplastic polyether-ester elastomers can replace polyurethane elastic fibers, many scholars usually follow the example of polyurethane elastic fibers to use chemical crosslinking, by adding a chemical cross-linking agent with a multifunctional group to form a chemical crosslinking (e.g., patents CN100557095C, U.S. Pat. No. 6,562,457B1, and CN102060969B). However, thermoplastic polyether-ester elastomer is a polyester elastomer, of which fiber is usually processed by melt spinning. In the field of melt spinning, the addition of multi-functional additives such as cross-linking agents is usually avoided to prevent the generation of colloidal particles, which may cause process problems resulting from the rapid increase of pressure in the spinning nozzle and poor melt fluidity, and some melt spinning processes do not even use any chemical cross-linking agents at all. Therefore, if chemical cross-linking agent is added to form chemical crosslinking, the melt spinning process will have the dilemma of how to choose between the process problems such as too fast pressure rise and poor melt fluidity and the physical properties of the fiber, which also makes the application of thermoplastic polyether-ester elastomers in the use of fibrous materials and to replace the use of polyurethane elastic fibers with a certain degree of technical difficulty, and also means that if thermoplastic polyether-ester elastomers are to replace polyurethane elastic fibers, not only must we find ways to improve the physical properties of thermoplastic polyether-ester elastic fibers, but also must solve the problems of rapid pressure rise and poor mobility in the process of melt spinning.

Third, some scholars have attempted to mimic the main structure of polyurethane clastic fibers and use the introduction of functional groups containing hydrogen bonding structure to increase the resilience of thermoplastic polyether-ester elastomers (e.g., Taiwan Patent No. 1596133). This method requires the synthesis of amide oligomers, followed by the use of thermoplastic polyether-ester elastic materials obtained by copolymerization of ethylene terephthalate and polyalkylene glycol. Although a thermoplastic polyamide-based elastomer (TPAE) with higher resilience can be obtained, there are more steps in the synthesis and it is not conducive to mass produce. The obtained material cannot achieve the purpose of a single polyester material for the whole garment. In addition, blending only polymers with hydrogen-bonded structures has no effect on the resilience of thermoplastic polyether-ester elastomers.

### SUMMARY OF THE INVENTION

The problem addressed by the present invention is that when a chemical crosslinking is used in conventional polyether esters, it is easy to produce larger colloidal particles by adding an excessive amount of chemical cross-linking agents, thereby causing difficulties in spinning fibers. However, it will make the fibers less elastic when the amount of the chemical cross-linking agents is insufficient. Hence, the thermoplastic polyether-ester elastomer may not have good physical properties and the mass productivity of fibers at the same time. The present invention discloses a polyether-ester material with low hardness, high strain hardening and high resilience, and this polyether-ester material also has good fiber-spinning properties, thereby solving the long-standing dilemma of how to balance the process issues such as rapid pressure changes and poor melt flow caused by the melt spinning process when replacing polyurethane elastic fibers with thermoplastic polyether ester elastomers, and the trade-off between these process issues and the physical properties of the fibers. This polyether-ester material can be used for industrial mass production and can replace the traditional polyurethane elastic fiber, and achieve the purpose of single polyester material for the whole garment, and the difficulty of subsequent recycling and separation can be reduced.

The present invention discloses a thermoplastic polyether-ester elastic material with high strain hardening and high resilience, which is characterized by the selection of an inorganic material that can generate special forces (such as intermolecular forces) with polymer segments and can make a low-hardness thermoplastic polyether-ester elastomer have a high strain-hardening property. The fabrics made of the obtained thermoplastic polyether-ester elastic fiber not only have a good hand feel, excellent fiber properties and resilience, but also have the special physical property of high strain hardening similar to that of polyurethane elastic fiber. In addition, the thermoplastic polyether-ester elastomers with high strain hardening disclosed in the present invention do not have the problems of the rapid pressure rise and poor melt flowability in fiber spinning, and can be used for industrial mass production, thus solving the problem that thermoplastic polyether-ester elastomer cannot take both fiber physical properties and spinning processability into account. The thermoplastic polyether-ester elastomers with high strain hardening of the present invention can completely replace traditional polyurethane elastic fibers or other elastomers in a wide range of applications such as sports apparel, footwear, sports equipment, medical equipment, power machinery or engineering equipment.

One aspect of the present invention is to provide a special thermoplastic polyether-ester elastomer composition with high strain hardening and high resilience. The thermoplastic polyether-ester elastomer composition comprises polyester hard segments composed of repeating units of the general formula A, polyester-ether soft segments composed of repeating units of the general formula B, and at least one inorganic substance that generates intermolecular forces with the aforementioned segments, which can enable the composition to have a high strain-hardening property.

The repeating units of polyester hard segments in the aspect of the present invention is represented by the general formula A:

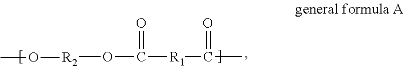

wherein R₁ is a chemical structure remaining of a dicarboxylic acid (ester) following removal of two carboxyl (ester) groups (—COOH, —COOR), the aforementioned dicarboxylic acid (ester) may be selected from a group consisting of terephthalic acid, methyl terephthalate, phthalic acid, methyl phthalate or isophthalic acid, methyl isophthalate, naphthalic acid (ester), adipic acid (ester), sebacic acid (ester), and the like, or derivatives thereof having molecular weights of 850 g/mol or less, but are not limited to the foregoing. R₂ is a chemical structure remaining of a diol following removal of two hydroxyl groups (—OH), the aforementioned diol may be selected from a group consisting of ethylene glycol, propylene glycol, butylene glycol, pentanediol, 2-methylpropanediol, 2,2-dimethylpropanediol, hexanediol, 1,2-dihydroxycyclohexane, 1,3-dihydroxycyclohexane, 1,4-dihydroxycyclohexane and mixtures thereof, and the like, or derivatives thereof having molecular weights of 500 g/mol or less, but are not limited to the foregoing.

In an embodiment, R₁ and R₂ each of the general formula A are independently a substituted or unsubstituted alkylene group, cycloalkylene group or arylene group. Preferably, R₁ is a substituted or unsubstituted arylene group having 6 to 10 carbon atoms or an alkylene group having 4 to 8 carbon atoms, and with a molecular weight of less than 850 g/mol, and R₂ is a substituted or unsubstituted alkylene group having 2 to 6 carbon atoms or a cycloalkylene group having 4 to 8 carbon atoms, and with a molecular weight of less than 500 g/mol. More preferably, R₁ is a phenylene group, a naphthylene group or an alkylene group having 4 to 8 carbon atoms, and R₂ is an alkylene group or a cycloalkylene group having 2 to 6 carbon atoms.

The repeating units of polyether-ester soft segments in the aspect of the present invention are represented by the general formula B:

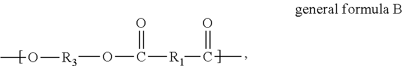

wherein R₁ is a chemical structure remaining of a dicarboxylic acid (ester) following removal of two carboxyl (ester) groups (—COOH, —COOR), the aforementioned dicarboxylic acid (ester) may be selected from a group consisting of terephthalic acid, methyl terephthalate, phthalic acid, methyl phthalate or isophthalic acid, methyl isophthalate, naphthalic acid (ester), adipic acid (ester), sebacic acid (ester), and the like, or derivatives thereof having molecular weights of 850 g/mol or less, but are not limited to the foregoing. R₃ is a chemical structure remaining of a polyether polyol following removal of two hydroxyl groups (—OH), the aforementioned polyether polyol may be selected from a group consisting of poly(vinyl ether) glycol, poly(propylene ether) glycol, poly(tetramethylene ether) glycol, poly(alkylene oxide) glycol, poly(pentamethylene ether) glycol, poly(hexamethylene ether) glycol, poly(heptamethylene ether) glycol, poly(octamethylene ether) glycol, poly(nonamethylene ether) glycol or poly(decamethylene ether) glycol, compositions comprising one or more polyether-polyol and derivatives thereof and also comprising the mixing of the same kind of polyether polyols with different molecular weights and derivatives thereof, but not limited to the foregoing. When the present invention is applied to elastic fiber materials in clothing, the molecular weight thereof is between 300 to 6,000 g/mol, and preferably between 1,000 and 4,000 g/mol.

In an embodiment, in the general formula B, R₁ is a substituted or unsubstituted alkylene group, cycloalkylene group or arylene group, and R₃ is a polyether group. Preferably, R₁ is a substituted or unsubstituted arylene group having 6 to 10 carbon atoms or an alkylene group having 4 to 8 carbon atoms, and with a molecular weight of less than 850 g/mol, and R₃ is a polyether group with a molecular weight of less than 300 g/mol to 6,000 g/mol. More preferably, R₁ is a phenylene group, a naphthylene group or an alkylene group having 4 to 8 carbon atoms, and R₃ is a polyether group with a molecular weight of less than 1,000 g/mol to 4,000 g/mol. Further more preferably, R₃ is at least one selected from the group consisting of polyethylene ether group, polypropylene ether group, polytetramethylene ether group, polyalkylene oxide group, polypentamethylene ether group, polyhexamethylene ether group, polyheptamethylene ether group, polyoctamethylene ether group, polynonamethylene ether group and polydecamethylene ether group.

The inorganic substances in the present invention which can produce high strain-hardening properties in low-hardness thermoplastic polyether-ester elastomer compositions are silicon dioxide, titanium dioxide, zinc oxide, alumina, aluminum silicate, zirconium oxide, or potassium titanate, or the like, or derivatives having the same effect.

In an embodiment, the inorganic substance is silicon dioxide, titanium dioxide, zinc oxide, aluminum oxide, aluminum silicate, zirconium oxide, or potassium titanate with an average particle diameter of ≤5 μm. Preferably, the inorganic substance is silicon dioxide, titanium dioxide, zinc oxide, aluminum oxide, aluminum silicate, zirconium oxide, or potassium titanate with an average particle diameter of ≤1 μm. More preferably, the inorganic substance is silicon dioxide or titanium dioxide with an average particle diameter of ≤1 μm.

In an embodiment, the inorganic substance is subjected to a surface treatment to improve the dispersibility of the inorganic substance.

In an embodiment, the total amount of the inorganic substance is from 0.001 wt % to 50 wt %, preferably from 0.01 wt % to 10 wt %, and more preferably from 0.1 wt % to 10 wt % relative to the amount of the polyether-ester elastomer composition.

In an embodiment, the polyether-ester elastomer composition has an intrinsic viscosity (IV) of ≥1.4 dL/g at 25° C., and preferably between 2.0 and 5.0 dL/g.

In an embodiment, the polyether-ester elastomer composition has a melt flow index (MI) at 230° C. of between 4 and 40 g/10 min, preferably between 8 and 25 g/10 min, and more preferably between 10 and 20 g/10 min.

In an embodiment, the polyether-ester elastomer composition has a Shore D hardness of between 15D and 65D, and preferably between 20D and 40D.

In an embodiment, the polyether-ester elastomer composition further comprises at least one additive or modifier, which is known to be suitable by anyone skilled in the art, including toners, antioxidants, anti-UV agents, a heat stabilizer, a protective agent, a lubricant, a filler, a deliquescent substance or an additive with other functional properties, but is not limited to such functional additives or modifiers. Within the spirit and scope of the present application, any modification may be made.

Another aspect of the present invention provides a high strain-hardened polyether-ester elastic fiber, which is characterized by that the polyether-ester elastomer fiber has a stress-strain curve of y=f(x) as determined according to ASTM D885, wherein x is a tensile strain value (Strain (%)) and y is a tensile stress value (F(g)). A slope of a secant line is ΔS1(g/%) and said secant line is formed by connecting two points of the minimum and maximum tensile stress values between 260% and 420% of the tensile strain value. In addition, a slope of another secant line is ΔS2(g/%) and said another secant line is formed by connecting two points of the minimum and maximum tensile stress values between 60% and 220% of the tensile strain value. The ratio (ΔS1/ΔS2) of the slope ΔS1 to the slope ΔS2 is ≥2.5, preferably ≥4.0, and more preferably ≥4.5.

In an embodiment, the high strain hardening polyether-ester elastic fiber, which is characterized by that the polyether-ester elastomer fiber has a stress-strain curve of y=f(x) as determined according to ASTM D885, wherein x is a tensile strain value (Strain (%)) and y is a tensile stress value (F(g)). When the tensile strain value is between 260% and 420%, the stress-strain curve is continuous, smooth, and differentiable, and a maximum slope of a tangent line at any point on an increasing segment of the stress-strain curve is f₁′(x)(g/%). In addition, when the tensile strain value is between 60% and 220%, the stress-strain curve is continuous, smooth, and differentiable, and a minimum slope of a tangent line at any point on an increasing segment of the stress-strain curve is f₂′(x)(g/%). The maximum slope f₁′(x) is ≥0.040 (g/%), preferably ≥0.045 (g/%), and more preferably ≥0.050 (g/%).

In an embodiment, the minimum slope f₂′(x) is ≤0.040 (g/%), preferably ≤0.035 (g/%), and more preferably ≤0.030 (g/%).

In an embodiment, the ratio (f₁′(x)/f₂′(x)) of the maximum slope f₁′(x) to the minimum slope f₂′(x) is ≥1.4, preferably ≥1.5, and more preferably ≥2.0.

In an embodiment, the Shore D hardness of the polyether-ester elastic fibers is between 15D and 65D, and preferably between 20D and 40D.

In an embodiment, the tensile stress value of the stress-strain curve of the polyether-ester elastic fiber is ≤5.0 g, preferably ≤4.5 g, and more preferably ≤4.0 g at the tensile strain value of 100%.

In an embodiment, the tensile stress value of the stress-strain curve of the polyether-ester elastic fiber is ≤10.0 g, preferably ≤9.0 g, and more preferably ≤8.0 g at the tensile strain value of 200%.

In an embodiment, the tensile stress value of the stress-strain curve of the polyether-ester clastic fiber is ≥16.0 g, preferably ≥16.5 g, and more preferably ≥17.0 g at the tensile strain value of 300%.

In an embodiment, the polyether-ester elastic fiber has an elastic recovery rate of the yarn at fixed elongation of ≥90%, preferably ≥95%, and more preferably ≥97%.

In an embodiment, a breaking strength of the polyether-ester clastic fiber is ≥0.9 g/d, preferably ≥1.0 g/d, and more preferably ≥1.2 g/d.

In an embodiment, the high strain hardening polyether-ester elastic fiber comprises the high strain hardening polyether-ester elastomer composition.

Another aspect of the present invention provides a method for preparing the aforementioned high strain hardening polyether-ester elastomer composition, the method comprising the following steps. In the step (1), at least one dicarboxylic acid, at least one diol and at least one polyether glycol are mixed and subjected to an esterification reaction in the presence of a first catalyst to obtain a reaction mixture. In the step (2), the reaction mixture is subjected to a polymerization reaction after adding a second catalyst to obtain the polyether-ester elastomer composition. Moreover, at least one inorganic substance is added in the esterification reaction step and/or the polymerization reaction step, the inorganic substance is selected from the group consisting of silicon dioxide, titanium dioxide, zinc oxide, aluminum oxide, aluminum silicate, zirconium oxide, potassium titanate and derivatives thereof, and the average particle diameter of the inorganic substance is ≤5 μm, and preferably ≤1 μm.

In an embodiment, the first catalyst and the second catalyst may be catalysts containing titanium (Ti), and the effective titanium content of the second catalyst of step (2)≥the effective titanium content of the first catalyst of step (1) ≥10 ppm, and preferably ≥50 ppm.

In an embodiment, the titanium-containing catalyst may be, for example, tetraethyl titanate, tetra-n-propyl titanate, tetra-isopropyl titanate, tetra-n-butyl titanate, tetra-isobutyl titanate, tetra-tert-butyl titanate, tetra-cyclohexyl titanate, tetra-phenyl titanate, titanium oxalate, titanic acid phthalate, trimellitic acid titanate, pyromelitic acid titanate, butyl titanate dimer, tetraoctyl titanate, titanium acetylacetonate, titanium tetraacetylacetonate, ethyl acetoacetate titanium, or the like. The above titanium-containing catalysts can be one or a combination of two or more.

In an embodiment, the molar ratio of the diol to the dicarboxylic acid in the esterification reaction step is ≥1.5, and preferably ≥2.0.

In an embodiment, the temperature of the esterification reaction step is between 150° C. and 300° C., and preferably between 200° C. and 280° C. In addition, the pressure of the esterification reaction step is between 550 torr and 800 torr, and preferably between 600 torr and 760 torr.

In an embodiment, the temperature of the polymerization step is between 150° C. and 300° C., and preferably between 200° C. and 280° C. The pressure of the polymerization step is below 20 torr.

Another aspect of the present invention is to provide a method for preparing the aforementioned polyether-ester elastic fiber. The method comprises the aforementioned steps (1) and (2), and further comprises a step (3) of extruding the polyether-ester elastomer composition through a spinning nozzle at a temperature of 200° C. to 300° C., and spinning and stretching the polyether-ester elastomer composition after cooling with cooling air, wherein the rate of pressure increase of the spinning nozzle is not more than 0.5 kg/cm² per hour, and preferably not more than 0.1 kg/cm² per hour.

Another aspect of the present invention is to provide a use of the aforementioned high-strain hardening polyether-ester elastomer composition or polyether-ester clastic fiber, for manufacturing sportswear, footwear, sports equipment, medical equipment, power machinery or engineering equipment.

Another aspect of the present invention is to provide a high strain hardening polyether-ester elastic material, comprising the high strain hardening polyether-ester elastomer composition, wherein the polyether-ester elastic material is a raw material of ester granules, a yarn, a cloth, a film, a preform, a sheet or a foamed sheet.

The design of the thermoplastic polyether-ester elastic fiber composition in the prior art is modeled on that of the polyurethane elastic fibers composition of the thermoplastic polyether-ester elastic fiber by using a chemical cross-linking method to improve fiber properties. However, the increase in the amount of chemical crosslinking agent used will easily produce larger colloidal particles and cause fiber spinning problems, including the generation of colloidal particles with a particle diameter greater than 1,000 nm in the melt spinning process, which makes the spinning nozzle pressure rise faster and the melt fluidity is too poor, causing production problems. The present invention only needs to consider the agglomeration problem of the added inorganic substances, and the limitation of the added amount is smaller, so the physical properties of the thermoplastic polyether-ester elastomer can be greatly improved. According to experimental results, the high strain-hardening thermoplastic polyether-ester elastomer of the present invention is less likely to reduce the melt flow index and fluidity because of intermolecular forces (such as hydrogen bonds) rather than actual chemical crosslinking, and it can solve the long-standing dilemma that the physical properties of thermoplastic polyether-ester elastic fibers are difficult to replace polyurethane elastic fibers in melt spinning.

The present invention can generate an intermolecular hydrogen bonding effect similar to that of polyurethane clastic fiber by simply adding the aforementioned inorganic substance to the thermoplastic polyether-ester elastomer without further polymerization or introduction of other monomers containing hydrogen-bond structures. This can effectively enhance the physical properties of the thermoplastic polyether-ester elastic fiber, so that the obtained thermoplastic polyether-ester elastic material has high strain-hardening stress and high resilience similar to those of polyurethane elastic fiber. Therefore, the preparation method of the present invention is suitable for industrial mass production.

### BRIEF DESCRIPTION OF THE DRAWINGS

FIG. 1 shows the stress-strain curves of the polyether-ester elastic fibers of Example 1 (A1) and Comparative Example 1 (B1) and the elastic polyurethane ester fiber of Reference Example 1 (Spandex 1) as determined according to ASTM D885 specification.

FIG. 2 shows the stress-strain curves of the polyether-ester elastic fibers of Examples 2, 3 (A2, A3) and Comparative Example 2 (B2) and the elastic polyurethane ester fiber of Reference Example 2 (Spandex 2) as determined according to ASTM D885 specification.

FIG. 3 shows the stress-strain curves of the polyether-ester elastic fibers of Examples 4 (A4) and Comparative Examples 3, 4 (B3, B4) and the elastic polyurethane ester fiber of Reference Example 3 (Spandex 3) as determined according to ASTM D885 specification.

### DETAILED DESCRIPTION OF THE INVENTION

Other aspects of the embodiments of the present invention will be described in more detail below. It should be understood that the present invention may be embodied in different forms and should not be construed as limited to the embodiments described in the present invention. In contrast, the embodiments of the present invention are provided for fuller and more complete disclosure of the present invention, and enable the person having ordinary skill in the art to understand and carry out the present invention.

Unless otherwise stated, any numerical values, such as a concentration or a concentration range described herein, are to be understood as being modified in all instances by the term “about.” “About” means within an acceptable error range for the particular value as determined by one of ordinary skill in the art, which will depend in part on how the value is measured or determined, i.e., the limitations of the measurement system. Unless explicitly stated otherwise within the Examples or elsewhere in the Specification in the context of a particular assay, result or embodiment, “about” means within one standard deviation per the practice in the art, or a range of up to 5%, whichever is larger.

References to “one embodiment,” “an embodiment,” “some embodiments,” etc., indicate that the embodiment described may include a particular feature, structure, aspect, or characteristic, but every embodiment may not necessarily include the particular feature, structure, aspect, or characteristic. Moreover, such phrases are not necessarily referring to the same embodiment. Further, when a particular feature, structure, aspect, or characteristic is described in connection with an embodiment, it is submitted that it is within the knowledge of one skilled in the art to effect such feature, structure, or characteristic in connection with other embodiments whether or not explicitly described.

All technical and scientific terms used in the specification and the appended claims, unless otherwise defined, are defined as those commonly known by a person with ordinary skills in the art. The singular forms “a,” “an” and “the” include plural referents unless the context clearly dictates otherwise. In this application, the use of “or” or “and” means “and/or” unless stated otherwise. Furthermore, use of the term “including” as well as other forms, such as “include”, “includes,” and is not “included,” limiting. The section headings used herein are for organizational purposes only and are not to be construed as limiting the subject matter described. Unless otherwise specified, all the material used herein is commercial and can be easily obtained.

### A High Strain Hardening Polyether-Ester Elastomer Composition

One embodiment of the present invention is a high strain hardening polyether-ester elastomer composition, which is a block copolymer composed of polyester hard segments and polyester-ether soft segments and an inorganic additive that produces a certain force effect (such as intermolecular hydrogen bonding) with the polymer. Moreover, due to the special force in the polymer segments, the composition has a high strain-hardening phenomenon, that is, the tensile stress-strain diagram of the composition presents a curve similar to exponential growth from low stress in the low deformation area to high stress in the high deformation area.

The high strain hardening polyether-ester elastomer composition of the embodiment, which comprises polyester hard segments composed of repeating units of the general formula A, polyether-ester soft segments composed of repeating units of the general formula B, and at least one inorganic substance that generates intermolecular forces with the aforementioned segments.

The repeating unit of polyester hard segments in the embodiment is represented by the general formula A:

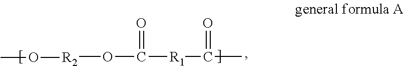

wherein R₁ is a chemical structure remaining of a dicarboxylic acid (ester) following removal of two carboxyl (ester) groups (—COOH, —COOR). The chemical structure remaining may be represented by a substituted or unsubstituted alkylene group, cycloalkylene group or arylene group. The aforementioned dicarboxylic acid (ester) may be selected from a group consisting of terephthalic acid, methyl terephthalate, phthalic acid, methyl phthalate or isophthalic acid, methyl isophthalate, naphthalic acid (ester), adipic acid (ester), sebacic acid (ester), and the like, or derivatives thereof having molecular weights of 850 g/mol or less, but are not limited to the foregoing. R₂ is a chemical structure remaining of a diol following removal of two hydroxyl groups (—OH). The chemical structure remaining may be represented by a substituted or unsubstituted alkylene group, cycloalkylene group or arylene group. The aforementioned diol may be selected from a group consisting of ethylene glycol, propylene glycol, butylene glycol, pentanediol, 2-methylpropanediol, 2,2-dimethylpropanediol, hexanediol, 1,2-dihydroxycyclohexane, 1,3-dihydroxycyclohexane, 1,4-dihydroxycyclohexane and mixtures thereof, etc., or derivatives thereof having molecular weights of 500 g/mol or less, but are not limited to the foregoing. Therefore, R₁ may be a substituted or unsubstituted arylene group having 6 to 10 carbon atoms or an alkylene group having 4 to 8 carbon atoms, and with a molecular weight of less than 850 g/mol. R₂ may be a substituted or unsubstituted alkylene group having 2 to 6 carbon atoms or a cycloalkylene group having 4 to 8 carbon atoms, and with a molecular weight of less than 500 g/mol. More preferably, R₁ is a phenylene group, a naphthylene group or an alkylene group having 4 to 8 carbon atoms, such as a p-phenylene group, an o-phenylene group, a m-phenylene group, a naphthylene group, a butylene group, a 1-methylpropylene group, a 2-methylpropylene group, a 1,2-dimethylpropylene group, a 1,3-dimethylpropylene group, a 1-methylbutylene group, a 2-methylbutylene group, a 3-methylbutylene group, a 4-methylbutylene group, a 2,4-dimethylbutylene group, a 1,3-dimethylbutylene group, a pentylene group, a hexylene group, a heptylene group, an octylene group, or the like. R₂ is an alkylene group or a cycloalkylene group with 2 to 6 carbon atoms, such as ethylene group, propylene group, methylethylene group, butylene group, 1-methylpropylene group, 2-methylpropylene group, 1,2-dimethylpropylene group, 1,3-dimethylpropylene group, 1-methylbutylene group, 2-methylbutylene group, 3-methylbutylene group, 4-methylbutylene group, 2,4-dimethylbutylene group, 1,3-dimethylbutylene group, pentylene group, hexylene group, or the like.

The repeating unit of polyether-ester soft segments in the embodiment is represented by the general formula B:

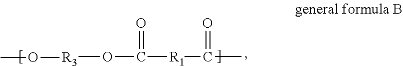

wherein R₁ is a chemical structure remaining of a dicarboxylic acid (ester) following removal of two carboxyl (ester) groups (—COOH, —COOR). The chemical structure remaining may be represented by a substituted or unsubstituted alkylene group, cycloalkylene group or arylene group. The aforementioned dicarboxylic acid (ester) may be selected from a group consisting of terephthalic acid, methyl terephthalate, phthalic acid, methyl phthalate or isophthalic acid, methyl isophthalate, naphthalic acid (ester), adipic acid (ester), sebacic acid (ester), and the like, or derivatives thereof having molecular weights of 850 g/mol or less, but are not limited to the foregoing. R₃ is a chemical structure remaining of a polyether polyol following removal of two hydroxyl groups (—OH). The chemical structure remaining may be a polyether group. The aforementioned polyether polyol may be selected from a group consisting of poly(vinyl ether) glycol, poly(propylene ether) glycol, poly(tetramethylene ether) glycol, poly(alkylene oxide) glycol, poly(pentamethylene ether) glycol, poly(hexamethylene ether) glycol, poly(heptamethylene ether) glycol, poly(octamethylene ether) glycol, poly(nonamethylene ether) glycol or poly(decamethylene ether) glycol, compositions comprising one or more polyether-polyol and derivatives thereof and also comprising the mixing of the same kind of polyether polyols with different molecular weights and derivatives thereof, but not limited to the foregoing. When the present invention is applied to elastic fiber materials in clothing, the molecular weight thereof is between 300 to 6,000, and preferably between 1,000 and 4,000. Therefore, R₁ may be a substituted or unsubstituted arylene group having 6 to 10 carbon atoms or an alkylene group having 4 to 8 carbon atoms, and with a molecular weight of less than 850 g/mol. R₃ may be a polyether group with a molecular weight of between 300 g/mol to 6,000 g/mol, and preferably between 1,000 and 4,000. More preferably, R₁ is a phenylene group, a naphthylene group or an alkylene group having 4 to 8 carbon atoms, such as a p-phenylene group, an o-phenylene group, a m-phenylene group, a naphthylene group, a butylene group, a 1-methylpropylene group, a 2-methylpropylene group, a 1,2-dimethylpropylene group, a 1,3-dimethylpropylene group, a 1-methylbutylene group, a 2-methylbutylene group, a 3-methylbutylene group, a 4-methylbutylene group, a 2,4-dimethylbutylene group, a 1,3-dimethylbutylene group, a pentylene group, a hexylene group, a heptylene group, an octylene group, or the like. R₃ is at least one selected from the the group consisting of polyethylene ether group, polypropylene ether group, polytetramethylene ether group, polyalkylene oxide group, polypentamethylene ether group, polyhexamethylene ether group, polyheptamethylene ether group, polyoctamethylene ether group, polynonamethylene ether group and polydecamethylene ether group.

The inorganic substance in this embodiment that generates intermolecular forces to produce a high strain hardening in a low-hardness polyether-ester elastomer is silicon dioxide, titanium dioxide, zinc oxide, aluminum oxide, aluminum silicate, zirconium oxide or potassium titanate, or derivatives with equivalent effects.

In an embodiment, the inorganic substance is silicon dioxide, titanium dioxide, zinc oxide, aluminum oxide, aluminum silicate, zirconium oxide, potassium titanate, or derivatives thereof, having an average particle diameter of ≤5.0 μm, such as an average particle diameter of 5.0 μm, 4.0 μm, 3.0 μm, 2.0 μm, 1.0 μm, 0.5 μm, 0.3 μm, 0.1 μm, 0.05 μm, 0.01 μm, or any value or range between any two of the aforementioned values. Preferably, the inorganic substance is silicon dioxide, titanium dioxide, zinc oxide, aluminum oxide, aluminum silicate, zirconium oxide, or potassium titanate with an average particle diameter of ≤1.0 μm. More preferably, the inorganic substance is silicon dioxide or titanium dioxide with an average particle diameter of ≤1.0 μm.

In an embodiment, the inorganic substance is silicon dioxide, titanium dioxide, zinc oxide, aluminum oxide, aluminum silicate, zirconium oxide, potassium titanate, or derivatives thereof, which are subjected to a surface treatment to improve the dispersibility of the inorganic substance and to generate intermolecular forces (e.g., intermolecular hydrogen bonding) between the inorganic substance and the polymer segments of the polyether-ester elastomer composition.

In an embodiment, the amount of the aforementioned inorganic substance contained in the polyether-ester elastomer composition is 0.001 wt % to 50.0 wt % relative to the amount of the composition, for example, 0.001 wt %, 0.005 wt %, 0.010 wt %, 0.050 wt %, 0.10 wt %, 0.20 wt %, 0.30 wt %, 0.40 wt %, 0.50 wt %, 0.60 wt %, 0.70 wt %, 0.80 wt %, 0.90 wt %, 1.0 wt %, 2.0 wt %, 3.0 wt %, 4.0 wt %, 5.0 wt %, 6.0 wt %, 7.0 wt %, 8.0 wt %, 9.0 wt %, 10.0 wt %, 20.0 wt %, 30.0 wt %, 40.0 wt %, 50.0 wt %, or any value or range between any two of the aforementioned values, and preferably between 0.01 wt % and 10.0 wt %.

The high strain hardening polyether-ester elastomer composition of the present embodiment can be specified by various parameters measured from the high strain hardening polyether-ester elastomer composition, yarns and fabrics produced therefrom, as described below.

(1). Intrinsic viscosity (IV) is an intrinsic resistance of a polymer to flow, which can be measured by conventional technical methods in this field, such as the method according to ASTM D2857-01.

According to the disclosure of the present application, the intrinsic viscosity is measured according to ASTM D2857-01. The intrinsic viscosity of the high strain hardening polyether-ester elastomer composition in the present embodiment at 25° C. is ≥1.4 dL/g, such as 1.4 dL/g, 1.5 dl/g, 1.6 dL/g, 1.7 dL/g, 1.8 dl/g, 1.9 dL/g, 2.0 dL/g, 2.1 dL/g, 2.2 dL/g, 2.3 dL/g, 2.4 dL/g, 2.5 dL/g, 2.6 dL/g, 2.7 dL/g, 2.8 dL/g, 2.9 dL/g, 3.0 dL/g, 3.5 dL/g, 4.0 dL/g, 5.0 dL/g, 5.5 dL/g, or any value or range between any two of the aforementioned values, and preferably between 2.0 dL/g and 5.0 dL/g.

(2). Melt Flow Index (MI) is an important indicator of the flow properties of polymer melts, which can be measured by general technical methods in this field, such as the method according to ASTM D1238.

According to the disclosure of the present application, the melt flow index is measured at 230° C. according to ASTM D1238. The melt flow index of the high strain hardening polyether-ester elastomer composition in the present embodiment at 25° C. is between 4 g/10 min and 40 g/10 min, such as 4 g/10 min, 5 g/10 min, 6 g/10 min, 7 g/10 min, 8 g/10 min, 9 g/10 min, 10 g/10 min, 11 g/10 min, 12 g/10 min, 13 g/10 min, 14 g/10 min, 15 g/10 min, 16 g/10 min, 17 g/10 min, 18 g/10 min, 19 g/10 min, 20 g/10 min, 25 g/10 min, 30 g/10 min, 35 g/10 min, 40 g/10 min, or any value or range between any two of the aforementioned values, and preferably between 8 g/10 min and 25 g/10 min.

(3). Shore D hardness is an important indicator about the hardness of polymers, which can be measured by conventional technical methods in this field, such as the method according to ASTM D2240.

According to the disclosure of the present application, the Shore D hardness is measured by using a durometer for 15 seconds according to ASTM D2240. The Shore D hardness of the high strain hardening polyether-ester elastomer composition in the present embodiment is between 15D and 65D, such as 15D, 20D, 25D, 30D, 35D, 40D, 45D, 50D, 55D, 60D, 65D, or any value or range between any two of the aforementioned values, and preferably between 20D and 40D.

### Method for Manufacturing the High Strain Hardening Polyether-Ester Elastomer Composition

One embodiment of the present invention provides a method for manufacturing the high strain hardening polyether-ester elastomer composition. The manufacturing method comprises:
Step (1). Esterification reaction: In the presence of a catalyst, a diol, a dicarboxylic acid, and a polyether diol are mixed and esterified in a reactor equipped with a distillation column that can be maintained at a temperature ranging from 80° C. to 150° C., under appropriate conditions such as an internal temperature of the reaction system of 180° C. to 250° C. and a pressure of 600 torr to 760 torr (or pressurized or at atmospheric pressure), wherein the molar ratio of the diol to the dicarboxylic acid is ≥1.5.
Step (2). Polymerization reaction, which includes the step (2-1): prepolymerization reaction and the step (2-2): final polymerization reaction. For the step (2-1), in the presence of an additional catalyst, a catalyst is further added to the reaction mixture of step (1) and a prepolymerization reaction is carried out under reduced pressure, which may be carried out at a system temperature of 200° C. to 280° C. and a pressure of 3 torr to 20 torr. For the step (2-2), a polymerization reaction of the prepolymer obtained after the reaction of step (2-1) is carried out under a pressure lower than that of step (2-1). The reaction can be carried out under the conditions of a system temperature of 200° C. to 280° C. and a pressure of 3 torr or less. When the reaction reaches a predetermined endpoint, the reactants are cooled in water to form strips or cut into granules.

In an embodiment, the effective titanium content of the catalyst added in the aforesaid step (1) and step (2) may each be 10 ppm or more, wherein the effective titanium content of the catalyst added in step (2) may be greater than or equal to that added in step (1).

In an embodiment, in the aforementioned step (1) or step (2), an inorganic substance, such as silicon dioxide, titanium dioxide, zinc oxide, alumina, aluminum silicate, zirconium oxide, potassium titanate, or the like, or derivatives thereof having the same effect, is added to the polymer segments of the material to produce a special interaction force (intermolecular hydrogen bonding).

In an embodiment, the average particle diameter of the aforementioned added inorganic substance is ≤5.0 μm, such as 5.0 μm, 4.0 μm, 3.0 μm, 2.0 μm, 1.0 μm, 0.5 μm, 0.3 μm, 0.1 μm, 0.05 μm, 0.01 μm, or any value or range between any two of the aforementioned values. In an embodiment, the inorganic substance is subjected to a surface treatment to improve the dispersibility of the inorganic substance and to generate intermolecular forces (e.g., intermolecular hydrogen bonding) between the inorganic substance and the polymer segments of the polyether-ester elastomer composition. For example, commercially available silicon dioxide may be used in this embodiment, and its specification number may be AF-010, AERODISP G 1220, or AEROSIL OX 50. Commercially available titanium dioxide may also be used, and its specification number may be DTA-500 or GF-700. The average particle diameter of the inorganic substance in the aforementioned embodiments is <1 μm, and the inorganic substance is subjected to a surface treatment to generate intermolecular forces (e.g., intermolecular hydrogen bonding) with the polymer segments of the polyether-ester elastomer composition, thereby enhancing the physical properties of the materials and improving the dispersibility, making it suitable for use in the melt spinning process.

In an embodiment, any additives known to be suitable by those skilled in the art may be added to the aforementioned steps (1) and/or (2), including toners, antioxidants, heat stabilizers, protective agents, gliders, fillers, moisture absorbing agents, functional additives, and the like.

### Method for Manufacturing the High Strain Hardening Polyether-Ester Elastic Fiber

Another embodiment of the present invention provides a method for manufacturing the high strain hardening polyether-ester elastic fiber. The high strain hardening polyether-ester clastic fiber comprises the aforementioned high strain hardening polyether-ester elastomer composition. The method not only comprises the method of preparing the polyether-ester elastomer composition in the aforementioned embodiment but also further comprises a step (3). spinning and stretching: The obtained high strain hardening polyether-ester elastomer composition is extruded through a spinning nozzle at a temperature of 200° C. to 300° C., and then spun and stretched after being cooled by cooling air to obtain high strain hardening polyether-ester elastic fibers.

In an embodiment, in the step (3). the rate of pressure increases of the spinning nozzle during the spinning and extension process does not exceed 0.5 kg/cm² per hour, such as the rate of pressure increase of the spinning nozzle is 0.5 kg/cm², 0.4 kg/cm², 0.3 kg/cm², 0.2 kg/cm², 0.1 kg/cm², 0.09 kg/cm², 0.08 kg/cm², 0.07 kg/cm², 0.06 kg/cm², 0.05 kg/cm², 0.04 kg/cm², 0.03 kg/cm², 0.02 kg/cm², 0.01 kg/cm², or any value or range between any two of the aforementioned values.

### The High Strain Hardening Polyether-Ester Elastic Fiber

Another embodiment of the present invention is a high strain hardening polyether-ester elastic fiber manufactured by the aforementioned method, which comprises the aforementioned high strain hardening polyether-ester elastomer composition. The physical properties of the highly strain-hardening polyether-ester elastic fiber of this embodiment can be specified by various parameters measured from the fiber, as described below.

(1). Fiber strength (breaking strength) and fiber elongation (breaking elongation) are measured by using a STATIMAT ME automatic tensile tester (Textechno Inc, Germany) according to ASTM D885. The breaking strength (g/d) and breaking elongation (E %) of the fiber can be measured.

According to the disclosure of the present application, the high strain-hardening polyether-ester elastic fiber of the embodiment has a breaking strength of ≥0.9 g/d, such as 0.9 g/d, 1.0 g/d, 1.1 g/d, 1.2 g/d, 1.3 g/d, 1.4 g/d, 1.5 g/d, 2.0 g/d, or any value or range between any two of the aforementioned values.

(2). Elastic recovery rate of the yarn at fixed elongation. The measurement method of this embodiment is to first take 3 samples of yarn with a length of 60 cm, fix one end of the sample to the upper fixing clamp, hang a preload of 0.01 g/De on the other end, mark the interval of 50 cm, clamp the mark with another clamp so that the distance between the clamps of the sample is 50 cm (length of L0), then stretch the sample by 20% (length of L1) at a stretching speed of 50 cm/min, leave the sample for 1 min and then return to the original position at the same speed, repeat the stretching method for 5 times, open the clamp and hang a preload, measure its length (length of L2), and calculate the elastic recovery rate of the yarn using the following formula. The measurement results are expressed as the average rate of 3 times.

According to the disclosure of the present application, the elastic recovery rate of the yarn at fixed elongation of the high strain hardening polyether-ester elastic fiber in the present embodiment is ≥90%, such as 90%, 91%, 92%, 93%, 94%, 95%, 96%, 97%, 98%, 99%, 99.5%, or any value or range between any two of the aforementioned values.

(3). A Stress-Strain curve is used to represent the relationship between stress and strain of a particular material, which can be measured by conventional technical methods in this field, such as the method according to ASTM D885.

According to the disclosure of the present application, the stress-strain curve is measured by using a STATIMAT 4 automatic tensile tester according to the ASTM D885. The stress-strain curve of the high strain hardening polyether-ester elastic fiber of the present embodiment has a secant line, which is formed by connecting two points of the minimum and maximum tensile stress values between 260% and 420% of the tensile strain value, and with a slope ΔS1(g/%). The stress-strain curve has another secant line, which is formed by connecting two points of the minimum and maximum tensile stress values between 60% and 220% of the tensile strain value, with a slope ΔS2(g/%). In one embodiment, the slope ΔS1 ≥0.10 (g/%), such as 0.10, 0.11, 0.12, 0.13, 0.14, 0.15, 0.16, 0.17, 0.18, 0.19, 0.20, 0.25, 0.30, or any value or range between any two of the aforementioned values. In one embodiment, the slope ΔS2 ≤0.060 (g/%), such as 0.060, 0.055, 0.050, 0.045, 0.040, 0.035, 0.030, 0.025, 0.020, 0.015, or any value or range between any two of the aforementioned values. In one embodiment, the ratio of the slope ASI to the slope ΔS2 (ΔS1/ΔS2) ≥2.5, such as 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 5.0, 5.5, 6.0, or any value or range between any two of the aforementioned values.

According to the disclosure of the present application, the stress-strain curve of the high strain hardening polyether-ester elastic fiber has a curve function of y=f(x), wherein x is a tensile strain value (Strain (%)) and y is a tensile stress value (F(g)). A tangent line function is obtained by differentiating the curve function once. When the tensile strain value is between 260% and 420%, the stress-strain curve is continuous, smooth, and differentiable, and a maximum slope of a tangent line at any point on an increasing segment of the stress-strain curve is (f₁′(x)=dy/dx). In addition, when the tensile strain value is between 60% and 220%, the stress-strain curve is continuous, smooth, and differentiable, and a minimum slope of a tangent line at any point on an increasing segment of the stress-strain curve is (f₂′(x)=dy/dx), wherein the said continuous, smooth, differentiable and increasing segment of the stress-strain curve excludes discontinuous, non-smooth or jittery line segments on the curve. In an embodiment, the maximum slope of a tangent line f₁′(x)≥0.040 (g/%), such as 0.040, 0.045, 0.050, 0.055, 0.060, or any value or range between any two of the aforementioned values. In an embodiment, the minimum slope of a tangent line f₂′(x)≤0.040 (g/%), such as 0.040, 0.035, 0.030, 0.025, 0.020, 0.015, or any value or range between any two of the aforementioned values. In an embodiment, the ratio (f₁′(x)/f₂′(x)) of the maximum slope f₁′(x) to the minimum slope f₂′(x)≥1.4, such as 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 5.0, or any value or range between any two of the aforementioned values.

In an embodiment, the Shore D hardness of the high strain hardening polyether-ester clastic fiber is between 15D and 65D, such as 15D, 20D, 25D, 30D, 35D, 40D, 45D, 50D, 55D, 60D, 65D, or any value or range between any two of the aforementioned values, and preferably between 20D and 40D.

Another embodiment of the present invention provides a use of the aforementioned polyether-ester elastomer composition or the aforementioned polyether-ester elastic fiber for manufacturing sportswear, footwear, sports equipment, medical equipment, power machinery or engineering equipment.

Another embodiment of the present invention provides a high strain hardening polyether-ester elastic material, comprising the high strain hardening polyether-ester elastomer composition, wherein the polyether-ester elastic material is a raw material of ester granules, a yarn, a cloth, a film, a preform, a sheet or a foamed sheet.

The foregoing description, for purposes of explanation, employs specific nomenclature to provide a thorough understanding of the described embodiments. However, it will be apparent to one skilled in the art that many of the specific details are not required in order to practice the described embodiments. Thus, the foregoing descriptions of the specific embodiments described herein are presented for the purposes of illustration and description. They are not intended to be exhaustive or to limit the embodiments to the precise forms disclosed. It will be apparent to one of ordinary skill in the art that many modifications and variations are possible in view of the above teachings.

The Summary and Abstract sections may set forth one or more but not all exemplary embodiments of the present invention as contemplated by the inventors, and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments but should be defined only in accordance with the following claims and their equivalents.

Except for the above recitation of the embodiments, the remaining details of the embodiments of the present disclosure can be implemented with reference to the general skills in the art. Some specific examples are listed below for further explanation. However, the claimed invention is not limited to the specific examples listed below. The specific examples listed in the present disclosure are for illustrative purposes only. The claimed invention of the present disclosure may be extended to similar products with the same concept. While any methods and materials similar or equivalent to those described herein may be used in carrying out or experimenting with the embodiments and/or examples of the claimed invention, the disclosure herein is to the preferred methods and materials. All documents referred to in the present disclosure are incorporated herein by reference in their entirety.

### Example 1: Polyether-Ester Elastomer Composition Containing 4 Parts by Weight of Titanium Dioxide (DTA-500) and the Fiber Thereof

190.3 parts by weight of terephthalic acid (PTA), 206.46 parts by weight of 1,4-butanediol (BG), 148.0 parts by weight of polytetramethylene ether glycol (PTMEG) and a catalyst having 55 ppm effective titanium content are mixed, wherein the molar ratio of 1,4-butanediol to terephthalic acid is 2.0, and an esterification reaction is carried out at an internal temperature of 180° C. to 250° C. and a pressure of 600 torr to 760 torr (or normal pressure, pressurized), and the esterification reaction proceeds until the esterification rate exceeds 97%. After the esterification reaction is completed, a catalyst with 200 ppm effective titanium content, 1200 ppm of Irganox 1010 as an antioxidant, and 4 parts by weight of titanium dioxide (DTA-500) are added to the reactor, wherein the titanium dioxide (DTA-500) is subjected to a surface treatment to improve its dispersibility and has an average particle diameter of about 0.2 μm to 0.3 μm. The prepolymerization reaction (i.e., precondensation reaction) is carried out at an internal temperature of 200° C. to 280° C. and a pressure of 3 torr to 20 torr. After the prepolymerization reaction reaches the preset torque value, the final polymerization reaction is carried out at an internal temperature of 200° C. to 280° C. and a pressure of less than 3 torr. At the end point of the reaction, the reactants are poured into water for cooling so that the reactants are formed into strips or granules, which is a high strain hardening polyether-ester elastomer composition. The composition is measured by a durometer according to ASTM D2240 for 15 seconds and has a Shore D hardness of about 35D±2.

The high strain hardening polyether-ester elastomer composition is further extruded through a spinning nozzle at a temperature of 200° C. to 300° C. and then spun and stretched at a rate of 600 to 2000 m/min after cooling by air, resulting in a high strain hardening polyether-ester clastic fiber.

### Example 2: Polyether-Ester Elastomer Composition Containing 4 Parts by Weight of Silicon Dioxide (AEROSIL OX 50) and the Fiber Thereof

The synthesis method is almost the same as that of Example 1, except that in Example 1, 4 parts by weight of titanium dioxide (DTA-500) are added after the esterification reaction, while in Example 2, 4 parts by weight of silicon dioxide (AEROSIL OX 50) are added before the esterification reaction. The silicon dioxide (AEROSIL OX 50) is subjected to a surface treatment to improve its dispersibility, and the average particle diameter thereof is approximately ≤1 μm.

### Example 3: Polyether-Ester Elastomer Composition Containing 0.8 Parts by Weight of Silicon Dioxide (AEROSIL OX 50) and the Fiber Thereof

The synthesis method is almost the same as that of Example 2, except that in Example 2, 4 parts by weight of silicon dioxide (AEROSIL OX 50) are added, while in Example 3, only 0.8 parts by weight of silicon dioxide (AEROSIL OX 50) are added.

### Example 4: Polyether-Ester Elastomer Composition Containing 32 Parts by Weight of Silicon Dioxide (AEROSIL OX 50) and the Fiber Thereof

The synthesis method is almost the same as that of Example 2, except that in Example 4, 32 parts by weight of silicon dioxide (AEROSIL OX 50) are added.

### Comparative Example 1: Polyether-Ester Elastomer Composition Without Inorganic Substance and the Fiber Thereof

The synthesis method is almost the same as that of Examples 1 and 2, except that in Comparative Example 1, neither titanium dioxide (DTA-500) nor silicon dioxide (AEROSIL OX 50) is added.

### Comparative Example 2: Polyether-Ester Elastomer Composition Containing 0.4 Parts by Weight of Propanetriol and the Fiber Thereof

The synthesis method is almost the same as that of Example 1, except that in Example 1, 4 parts by weight of titanium dioxide (DTA-500) are added, while in Comparative Example 2, 0.4 parts by weight (1,000 ppm) of propanetriol are added instead of the said titanium dioxide (DTA-500).

### Comparative Example 3: Polyether-Ester Elastomer Composition Containing 4 Parts by Weight of Conventional Titanium Dioxide Powder (Food Grade TiO₂ Powder from Emperor Chemical Co., Ltd.) and the Fiber Thereof

The synthesis method is almost the same as that of Example 1, except that in Example 1, 4 parts by weight of titanium dioxide (DTA-500) are added, while in Comparative Example 3, 4 parts by weight of conventional titanium dioxide powder (Food Grade TiO₂ Powder from Emperor Chemical Co., Ltd.). The conventional titanium dioxide powder is not subjected to a surface treatment and has a particle diameter of approximately 325 μm.

### Comparative Example 4: Polyether-Ester Elastomer Composition Containing 4 Parts by Weight of Conventional Silicon Dioxide Powder (98% SiO₂ Powder from Emperor Chemical Co., Ltd.) and the Fiber Thereof

The synthesis method is almost the same as that of Example 2, except that in Example 2, 4 parts by weight of silicon dioxide (AEROSIL OX 50) are added, while in Comparative Example 3, 4 parts by weight of conventional silicon dioxide powder (98% SiO₂ Powder from Emperor Chemical Co., Ltd.). The conventional silicon dioxide powder is not subjected to a surface treatment and has a particle diameter of approximately 63 μm.

Reference Examples 1 to 3 (Spandex 1 to Spandex 3) are polyurethane elastic fibers used in different batches of experiments at different times and dates. They have a significant high strain hardening phenomenon, so their stress-strain curve changes and related experimental data can be used as references for the above examples and comparative examples.

The results of the experimental data of the high strain hardening polyether-ester elastomer compositions in the aforementioned examples and the conventional polyether-ester elastomer compositions in the comparative examples are summarized in Table 1 below:

TABLE 1
Comparison of the properties of the high strain hardening
polyether-ester elastomer composition with those of
conventional polyether-ester elastomer composition

| | Shore D | MI | IV |
|---|---|---|---|
| Item | hardness | (g/10 min) | (dL/g) |
| Example 1 | 35 ± 2 | 14.8 | 2.20 |
| Example 2 | 35 ± 2 | 15.2 | 2.18 |
| Example 3 | 35 ± 2 | 15.0 | 2.25 |
| Example 4 | 35 ± 2 | 14.8 | 2.19 |
| Comparative Example 1 | 35 ± 2 | 14.6 | 2.33 |
| Comparative Example 2 | 35 ± 2 | 14.9 | 2.12 |
| Comparative Example 3 | 35 ± 2 | 14.8 | 2.32 |
| Comparative Example 4 | 35 ± 2 | 14.6 | 2.30 |

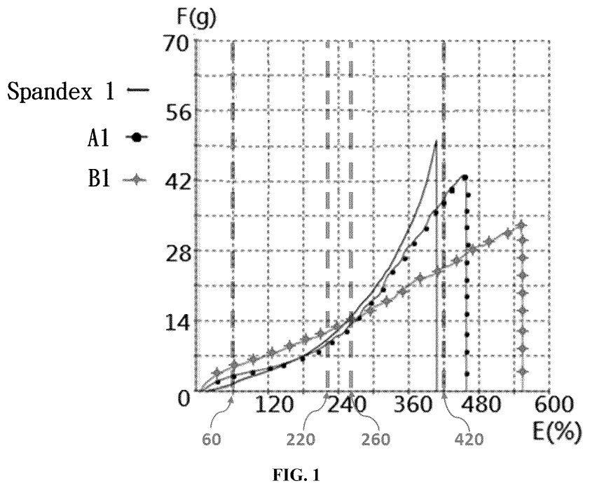

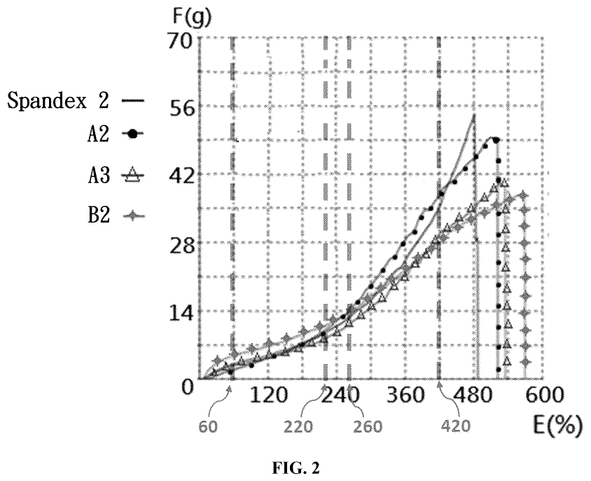

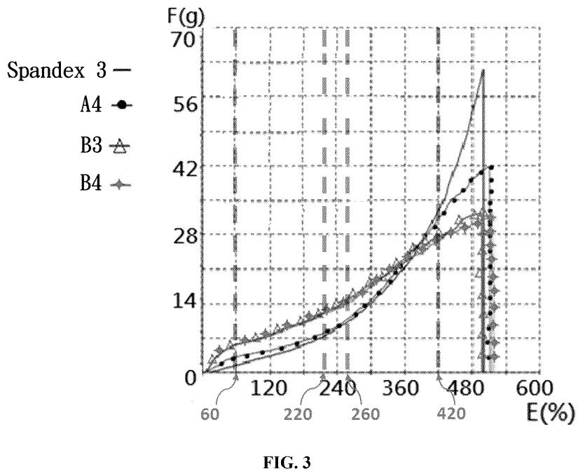

By observing the data results in Table 1, it can be found that the high strain hardening polyether-ester elastomer composition of Examples 1 to 4 has a Shore D hardness, melt flow index (MI) and intrinsic viscosity (IV) similar to those of the conventional polyether-ester elastomer composition of Comparative Examples 1 to 4, but the high strain hardening polyether-ester elastic fiber comprising the composition of Examples 1 to 4 has a stress-strain curve and a change trend that are significantly different from those of the conventional polyether-ester elastic fiber comprising the composition of Comparative Examples 1 to 4, as shown in the stress-strain curve diagrams of FIGS. 1 to 3.

The results of the experimental data of the high strain hardening polyether-ester elastic fibers in the aforementioned examples and the conventional polyether-ester elastic fibers in the comparative examples are summarized in Table 1 below:

TABLE 2
Comparison of the properties of the high strain hardening polyether-ester
elastic fibers with those of conventional polyether-ester elastic fibers

| | | Elastic | Breaking | Breaking | | | |
|---|---|---|---|---|---|---|---|
| | Shore D | recovery | strength | elongation | F100 | F200 | F300 |
| Item | hardness | rate (%) | (g/d) | E % | (g) | (g) | (g) |
| Example 1 | 35 ± 2 | 97.5 | 1.06 | 499 | 3.8 | 7.1 | 16.7 |
| Example 2 | 35 ± 2 | 98.1 | 1.23 | 510 | 4.3 | 8.6 | 19.2 |
| Example 3 | 35 ± 2 | 95.3 | 1.03 | 525 | 3.8 | 7.2 | 17.0 |
| Example 4 | 35 ± 2 | 97.2 | 1.08 | 508 | 4.1 | 7.2 | 17.6 |
| Comparative Example 1 | 35 ± 2 | 83.4 | 0.79 | 599 | 6.0 | 10.5 | 14.0 |
| Comparative Example 2 | 35 ± 2 | 86.4 | 0.93 | 569 | 6.0 | 10.1 | 14.6 |
| Comparative Example 3 | 35 ± 2 | 82.4 | 0.79 | 516 | 6.7 | 11.5 | 15.2 |
| Comparative Example 4 | 35 ± 2 | 81.9 | 0.83 | 497 | 6.8 | 11.3 | 14.2 |

By observing the data results in Table 2, it can be found that the high strain hardening polyether-ester elastic fibers of Examples 1 to 4 not only retain low hardness properties (Shore D hardness of between 20D and 40D) but also exhibit an excellent elastic recovery rate (elastic recovery rate ≥90.0%) and higher breaking strength (breaking strength ≥1.0 g/d) compared with the conventional polyether-ester elastic fibers of Comparative Examples 1 to 4.

The high strain hardening polyether-ester elastic fibers of Examples 1 to 4 also have a high strain hardening phenomenon which is not present in the conventional polyether-ester elastic fibers (such as Comparative Examples 1 to 4), as can be seen from F100, F200, F300 (the tensile stress value at 100%, 200%, and 300% of the tensile strain respectively) in Table 2 and the slope of the curve and its changing trend in the stress-strain curve diagrams of FIGS. 1 to 3. In Table 2, the F100 values of Examples 1 to 4 are all ≤5.0 g, and even the F100 values of Examples 1 and 3 are ≤4.0 g, while the F100 values of Comparative Examples 1 to 4 are between 6.0 g and 6.8 g. In addition, the F200 values of Examples 1 to 4 are all ≤10.0 g, and even the F200 values of Examples 1, 3 and 4 are ≤7.5 g, while the F200 values of Comparative Examples 1 to 4 are between 10 g and 12 g, indicating that the high strain hardening polyether-ester elastic fiber has a lower tensile stress strength than the conventional polyether-ester elastic fiber of the comparative examples at low tensile strain (i.e., at the tensile strain value of 100% or 200%). Moreover, the F300 values of Examples 1 to 4 are all ≥16.0 g, and even the F300 value of Example 2 is as high as 19.2 g, while the F300 values of Comparative Examples 1 to 4 are between 14.0 g and 15.5 g, indicating that the tensile stress strength of the high strain hardening polyether-ester elastic fiber at high tensile strain (i.e., at the tensile strain value of 300%) increases significantly and is even higher than that of the conventional polyether-ester elastic fibers in the comparative examples. This high strain hardening phenomenon can be more clearly observed through the changing trends of the stress-strain curves in FIGS. 1 to 3.

FIGS. 1 to 3 show the stress-strain curves of different examples, comparative examples and reference examples measured according to the ASTM D885, wherein A1 to A4 represent the stress-strain curves of the high strain hardening polyether-ester clastic fibers of Examples 1 to 4, respectively, B1 to B4 represent the stress-strain curves of the conventional polyether-ester elastic fibers of Comparative Examples 1 to 4, respectively, and Spandex 1 to 3 represent the stress-strain curves of the polyurethane elastic fibers of Reference Examples 1 to 3, respectively.

In the stress-strain curves of FIGS. 1 to 3, the x-axis represents the tensile strain value (E(%)) and the y-axis represents the tensile stress value (F(g)). The coordinate value (x, y) of any point on the curve represents the tensile stress value (y) corresponding to the specific fiber sample at a specific tensile strain value (x). The value of x between 60% and 220% is considered a low tensile strain, while the value of x between 260% and 420% is considered a high tensile strain.

In the stress-strain curves of FIGS. 1 to 3, the slope represents the trend of change in the corresponding tensile stress value when the tensile strain value changes. The larger slope (the steeper curve), the faster the increase in tensile stress value per unit increase in tensile strain value, wherein the slope of the tangent line at any point on the stress-strain curve represents the trend of the change in the tensile stress value under the specific tensile strain value, and the slope of the secant line between any two points on the stress-strain curve represents the change in the average tensile stress value within the range of the specific tensile strain value. Both the slopes of the tangent line and the secant line can be used to represent the trend of change in the stress-strain curve.

By observing the stress-strain curves of Examples 1 to 4 shown in FIGS. 1 to 3 and comparing the stress-strain curves of the comparative example with the reference examples, it can be found that Examples 1 to 4 have a high strain hardening phenomenon of the polyurethane elastic fiber of Reference Examples Spandex 1 to 3. This phenomenon shows that when the fiber is at a high tensile strain (i.e., at a tensile strain value of ≥260%), the change curve corresponding tensile stress value (Strain, in g) is significantly steeper and has a larger slope. When the fiber is at a low tensile strain (i.e., at a tensile strain value of between 60% and 220%), the stress change curve is significantly flatter and has a smaller slope. In comparison, there is no obvious difference in the slopes of the stress-strain curves of the conventional polyether-ester elastic fibers of Comparative Examples 1 to 4 in the high tensile strain region (at the tensile strain values of between 260% and 420%) and the low tensile strain region (at the tensile strain values of between 60% and 220%), which also shows that conventional low-hardness polyether-ester elastic fibers not only have poor fiber resilience but also do not have high strain hardening phenomenon.

In order to further illustrate the trend of the change in the stress-strain curves of the aforementioned different examples and comparative examples, the data results of the maximum slopes f₁′(x) of the tangent lines of these curves in the high tensile strain region (at the tensile strain value of between 260% and 420%) and the minimum slopes f₂′(x) of the tangent lines in the low tensile strain region (at the tensile strain value of between 60% and 220%) are summarized in the following Table 3:

TABLE 3
Slopes f₁′(x) and f₂′(x) of the tangent lines of the stress-strain curves
in high tensile strain and low tensile strain and the ratio thereof

| | | | Ratio of the |
|---|---|---|---|
| | 60%~220% | 260%~420% | slopes of |
| Item | f₂′(x)(g/%) | f₁′(x)(g/%) | f₁′(x)/f₂′(x) |
| Reference Example 1 | 0.013856 | 0.052376 | 3.78 |
| Example 1 | 0.020823 | 0.048183 | 2.31 |
| Example 2 | 0.029945 | 0.051905 | 1.73 |
| Example 3 | 0.031639 | 0.050359 | 1.59 |
| Example 4 | 0.023336 | 0.040616 | 1.97 |
| Comparative Example 1 | 0.055509 | 0.068469 | 1.23 |
| Comparative Example 2 | 0.051510 | 0.067350 | 1.30 |
| Comparative Example 3 | 0.052800 | 0.067200 | 1.27 |
| Comparative Example 4 | 0.053833 | 0.067873 | 1.26 |

By observing the slopes of the tangent lines recited in Table 3, it can be found that the minimum slopes f₂′(x) of the tangent lines of the stress-strain curves of Examples 1 to 4 in the low tensile strain region (at the tensile strain value of between 60% and 220%) are ≤0.040 (g/%), which means that the change of the tensile stress is lower at low tensile strain. However, the maximum slopes f₁′(x) of the tangent lines of the stress-strain curves of Examples 1 to 4 in the high tensile strain region (at the tensile strain values of between 260% and 420%) are significantly greater than the minimum slope f₂′(x) of the tangent lines in the low tensile strain region (at the tensile strain values of between 60% and 220%), which means that the tensile stress of the high strain hardening polyether-ester elastic fibers of Examples 1 to 4 will increase significantly at high tensile strain. It is calculated that the ratios of the maximum slope f₁′(x) of the tangent lines to the minimum slope f₂′(x) of the tangent lines of Examples 1 to 4 are all ≥1.4, and even the ratio (f₁′(x)/f₂′(x)) of Example 1 is ≥2.0. This result indicates that the polyether-ester elastic fibers of Examples 1 to 4 have high strain hardening capabilities. Compared with the values of Examples 1 to 4 mentioned above, the tensile stress value of the conventional polyether-ester elastic fiber of Comparative Examples 1 to 4 at high tensile strain (at the tensile strain value of between 260% and 420%) increases less significantly than the tensile stress at low tensile strain (at the tensile strain value of between 60% and 220%). The calculated ratios (f₁′(x)/f₂′(x)) of the comparative examples only fall between 1.20 and 1.30, indicating that they do not have the ability of high strain hardening.

In addition to the analysis of the slopes of tangent lines of the stress-strain curve mentioned above, the trend of the tensile stress change of different elastic fibers can be illustrated by the average tensile stress values in the high tensile strain region (at the tensile strain values of between 260% and 420%) and low tensile strain region (at the tensile strain values of between 60% and 220%) in different examples and comparative examples. Therefore, the data results of the slope ΔS1 of the secant line formed by connecting the two end points of the curves in the high tensile strain region (i.e., the minimum and maximum values of tensile stresses between 260% and 420%) and the slope ΔS2 of the secant lines formed by connecting the two end points of the curve in the low tensile strain region (i.e., the minimum and maximum values of tensile stresses between 60% and 220%) are summarized in Table 4 as follows:

TABLE 4
Slope ΔS1 of the secant line formed by connecting two endpoints
in the high tensile strain region and slope ΔS2 of the secant
line formed by connecting two endpoints in the low tensile strain
region of the stress-strain curve and the ratio thereof

| | 60%~220% | 260%~420% | Ratio of the |
|---|---|---|---|
| Item | ΔS2(g/%) | ΔS1(g/%) | slopes ΔS1/ΔS2 |
| Reference Example 1 | 0.046 | 0.210 | 4.62 |
| Example 1 | 0.039 | 0.150 | 4.39 |
| Example 2 | 0.051 | 0.130 | 2.55 |
| Example 3 | 0.023 | 0.109 | 4.67 |
| Example 4 | 0.023 | 0.126 | 5.38 |
| Comparative Example 1 | 0.043 | 0.069 | 1.63 |
| Comparative Example 2 | 0.044 | 0.103 | 2.33 |
| Comparative Example 3 | 0.039 | 0.068 | 1.76 |
| Comparative Example 4 | 0.039 | 0.060 | 1.55 |

Table 4 shows that the slope ΔS1 of the line connecting the endpoints of the stress-strain curves of Examples 1 to 4 in the high tensile strain region (at the tensile strain values of between 260% and 420%) is >0.10 (g/%), indicating that the high strain hardening polyether-ester elastic fibers of Examples 1 to 4 have a more significant growth trend in tensile stress under high tensile strain, and compared with the slope ΔS2 of the line connecting the endpoints of the curve covered in the low tensile strain region (at the tensile strain value of between 60% and 220%), the ratio ΔS1/ΔS2 is ≥2.5, and the ΔS1/ΔS2 of Example 4 can even exceed 5.0. This result is better than the ratio of 4.62 of the polyurethane elastic fiber of Reference Example 1, which also shows that the elastic fibers of Examples 1 to 4 have the ability of high strain hardening comparable to that of polyurethane elastic fibers. Compared with the values of ΔS1/ΔS2 of Comparative Examples 1 to 4, they are all less than 2.5, and most of them are even between 1.5 and 1.8, which further proves that the traditional polyether-ester elastic fibers do not have the ability of high strain hardening, and the change of tensile stress under high tensile strain (at the tensile strain values of between 260% and 420%) does not increase significantly.

If the focus is shifted to the spinning process of the polyether-ester elastic fibers, the data results on the rate of pressure increase of the spinning nozzle in the spinning process of polyether-ester elastic fiber of the above different examples and comparative examples, the elastic recovery rate of the obtained fibers and the breaking strength are summarized in the following Table 5:

TABLE 5
Comparison of the change of the spinning pressure rise between
the high strain hardening polyether-ester elastic fibers
and the conventional polyether-ester elastic fibers

| | Change of the | Elastic | Breaking |
|---|---|---|---|
| | spinning pressure | recovery | strength |
| Item | rise kg/cm²(hr) | rate(%) | (g/d) |
| Example 1 | 0.05 | 97.5 | 1.06 |
| Example 2 | 0.05 | 98.1 | 1.23 |
| Example 3 | 0.04 | 95.3 | 1.03 |
| Example 4 | 0.06 | 97.2 | 1.08 |
| Comparative Example 1 | 0.04 | 83.4 | 0.79 |
| Comparative Example 2 | 1.88 | 86.4 | 0.93 |
| Comparative Example 3 | 0.85 | 82.4 | 0.79 |
| Comparative Example 4 | 0.87 | 81.9 | 0.83 |

From the changes in spinning pressure rise of the examples and comparative examples recorded in Table 5, it can be found that Comparative Example 1 has a lower rate of change in spinning pressure rise when no inorganic substance or chemical crosslinking agent is added at all. Once 1,000 ppm of glycerol is added as a chemical crosslinking agent to enhance the elastic recovery rate and breaking strength (see Comparative Example 2), although the elastic recovery rate and breaking strength are slightly increased (the elastic recovery rate increases from 83.4% to 86.4%, and the breaking strength from 0.79 g/d to 0.93 g/d), the change in the spinning pressure rise in kg/cm²(hr) increases significantly from 0.04 kg/cm²(hr) to 1.88 kg/cm²(hr), making it difficult to be applied to melt spinning. Therefore, it falls into the aforementioned dilemma of the so-called prior art that cannot take into account both low change of spinning pressure rise and high elastic recovery rate, breaking strength and other fiber properties. In contrast, the rate of pressure increase of the spinning nozzle does not exceed 0.5 kg/cm², even not exceed 0.1 kg/cm², in the spinning process of the high strain hardening polyether-ester elastic fibers of Examples 1 to 4. Even though 40 times the amount of inorganic substance is added in Example 4 than in Example 3, the rate of pressure increase of the spinning nozzle in Example 4 only increases from 0.04 kg/cm²(hr) to 0.06 kg/cm²(hr), and the aforementioned problem of excessive pressure rise in the spinning process does not occur. It can be seen that the polyether-ester compositions of Examples 1 to 4 are more suitable for applications in the melt spinning method.

The above test results demonstrate that the selection of inorganic additives with suitable particle diameter, which can generate intermolecular forces (such as hydrogen bonding) with polymer segments after surface treatment and have good dispersibility, can more effectively improve the resilience of the fiber and at the same time solve the longstanding difficulties in melt spinning process, so as to make thermoplastic polyether-ester elastic fiber commercially feasible. Furthermore, the high strain hardening polyether-ester elastic fiber of the present invention has the physical properties similar to those of polyurethane fiber (Spandex) and can completely replace polyurethane fiber to achieve a single polyester material for all garments, thereby solving the problem of difficulties in recycling and processing of garments caused by the original use of polyurethane fiber products.

What is claimed is:

1. A high strain hardening polyether-ester elastomer composition, which comprises polyester hard segments composed of repeating units of the general formula A, polyether-ester soft segments composed of repeating units of the general formula B, and at least one inorganic substance, 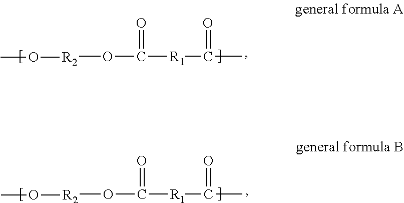
wherein
R₁ and R₂ are independently a substituted or unsubstituted alkylene group, cycloalkylene group or arylene group, and
R₃ is a polyether group; and
the at least one inorganic substance is selected from the group consisting of silicon dioxide, titanium dioxide, zinc oxide, aluminum oxide, aluminum silicate, zirconia, potassium titanate, and derivatives thereof.

2. The high strain hardening polyether-ester elastomer composition according to claim 1, wherein
R₁ is a substituted or unsubstituted arylene group with 6 to 10 carbon atoms or alkylene group with 4 to 8 carbon atoms, and with a molecular weight of less than 850 g/mol,
R₂ is a substituted or unsubstituted alkylene group with 2 to 6 carbon atoms or cycloalkylene group with 4 to 8 carbon atoms, and with a molecular weight of less than 500 g/mol, and
R₃ is a polyether group with a molecular weight of between 300 g/mol and 6,000 g/mol.

3. The high strain hardening polyether-ester elastomer composition according to claim 1, wherein the average particle diameter of the at least one inorganic substance is equal to or less than 5 μm.

4. The high strain hardening polyether-ester elastomer composition according to claim 1, wherein the at least one inorganic substance is subjected to a surface treatment to improve the dispersibility of the inorganic substance.

5. The high strain hardening polyether-ester elastomer composition according to claim 1, wherein the amount of the at least one inorganic substance is from 0.01 wt % to 10 wt % relative to the amount of the polyether-ester elastomer composition.

6. The high strain hardening polyether-ester elastomer composition according to claim 1, comprising an intrinsic viscosity (IV) at 25° C. equal to or greater than 1.4 dL/g.

7. The high strain hardening polyether-ester elastomer composition according to claim 1, comprising a melt flow index (MI) at 230° C. between 8 g/10 min and 25 g/10 min.

8. The high strain hardening polyether-ester elastomer composition according to claim 1, comprising a Shore D hardness between 15D and 65D.

9. The high strain hardening polyether-ester elastomer composition according to claim 1, which further comprises at least one additive or modifier, wherein the additive is a toner, an antioxidant, an anti-UV agent, a heat stabilizer, a protective agent, a lubricant, a filler, a deliquescent substance or an additive with other functional properties.

10. A high strain hardening polyether-ester elastomer fiber comprising the high strain hardening polyether-ester elastomer composition according to claim 1,wherein the polyether-ester elastomer fiber has a stress-strain curve of y=f(x) as determined according to ASTM D885, wherein x is a tensile strain value (Strain (%)) and y is a tensile stress value (F(g)), and when the tensile strain value is between 60% and 220%, the stress-strain curve is continuous, smooth, and differentiable, and a minimum slope of a tangent line at any point on an increasing segment of the stress-strain curve is f₂′(x)(g/%), and when the tensile strain value is between 260% and 420%, the stress-strain curve is continuous, smooth, and differentiable, and a maximum slope of a tangent line at any point on an increasing segment of the stress-strain curve is f₁′(x)(g/%), and the ratio (f₁′(x)/f₂′(x)) of the maximum slope f₁′(x) to the minimum slope f₂′(x) is greater than or equal to 1.4.

11. The high strain hardening polyether-ester elastomer fiber according to claim 10, comprising a Shore D hardness between 15D and 65D.

12. The high strain hardening polyether-ester elastomer fiber according to claim 10, comprising an elastic recovery rate of the yarn at fixed elongation equal to or greater than 90%.

13. The high strain hardening polyether-ester elastomer fiber according to claim 10, comprising a breaking strength equal to or greater than 0.9 g/d.

14. A high strain hardening polyether-ester elastomer fiber comprising the high strain hardening polyether-ester elastomer composition according to claim 1,wherein the polyether-ester elastomer fiber has a stress-strain curve of y=f(x) as determined according to ASTM D885, wherein x is a tensile strain value (Strain (%)) and y is a tensile stress value (F(g)), and a slope of a secant line which is formed by connecting two points of the minimum and maximum tensile stress values between 260% and 420% of the tensile strain value is ΔS1(g/%), and a slope of a secant line which is formed by connecting two points of the minimum and maximum tensile stress values between 60% and 220% of the tensile strain value is ΔS2(g/%), and the ratio (ΔS1/ΔS2) of the slope ΔS1 to the slope ΔS2 is greater than or equal to 2.5.

15. The high strain hardening polyether-ester elastomer fiber according to claim 14, comprising a Shore D hardness between 15D and 65D.

16. The high strain hardening polyether-ester elastomer fiber according to claim 14, comprising an elastic recovery rate of the yarn at fixed elongation equal to or greater than 90%.

17. The high strain hardening polyether-ester elastomer fiber according to claim 14, comprising a breaking strength equal to or greater than 0.9 g/d.

18. A high strain hardening polyether-ester elastic material, comprising the high strain hardening polyether-ester elastomer composition according to claim 1,wherein the polyether-ester elastic material is a raw material of ester granules, a yarn, a cloth, a film, a preform, a sheet or a foamed sheet.
